(19) United States
(12) Patent Application Publication
(10) Pub. No.: US 2025/0305852 A1
(43) Pub. Date: Oct. 2, 2025

(54) DETACHABLE SURVEY MECHANISM

(71) Applicant: FNV IP B.V., Leidschendam (NL)

(72) Inventors: Ryan Mumford Twilley, Lafayette, LA (US); Morgan Dewey Reed, Scott, LA (US); Jacob Irwin, Lafayette, LA (US); Travis Arndt, Waterloo, CA (US)

(21) Appl. No.: 18/625,068

(22) Filed: Apr. 2, 2024

(51) Int. Cl. G01C 21/00; G01S 17/89

(52) U.S. Cl. CPC G01C 21/3841; G01C 21/3848; G01S 17/89

(57) ABSTRACT

Disclosed is a portable, detachable survey mechanism that is easily calibrated without regardless of the vehicle to which it is associated. By allowing a detachable coupling, the survey mechanism is not dependent on a vehicle chassis or required to be integrated into a dedicated vehicle. The mechanism includes one or more three-dimensional sensors that measure a topography of the surface upon which the vehicle travels. A navigation system and inertial measurement unit can also be provided to determine the position and orientation of the mechanism at a given time. Unlocking insights from geodata, the present disclosure further relates to improvements in sustainability and environmental developments: together we create a safe and liveable world.

### TECHNICAL FIELD OF THE INVENTION

The present technology relates to a survey mechanism. In particular, the present technology relates to a detachable survey mechanism designed to require minimal calibration. Unlocking insights from geodata, the present disclosure further relates to improvements in sustainability and environmental developments: together we create a safe and liveable world.

### BACKGROUND

A survey mechanism typically refers to a device or system used for conducting surveys or collecting data in various fields such as land surveying, geographic information systems (GIS), construction, environmental monitoring, and scientific research. Traditional pavement survey mechanisms are integrated within a vehicle and collect data regarding a topography and texture of pavement. These pavement survey mechanisms can provide valuable insights into the need to repair cracks or potholes in the pavement, for example.

The fixed nature of traditional survey mechanisms limits the functionality of the vehicle upon which they are integrated. Moreover, the dependency on vehicle-specific systems constrains the adaptability of the surveying process to diverse terrains and environments. Such limitations hinder the efficiency and accessibility of surveying operations, particularly in remote or rugged areas where conventional vehicles may not be feasible or cost-effective to deploy.

### SUMMARY

The presently disclosed embodiments include a detachable survey mechanism for collecting data from a surface upon which the vehicle is traveling, such as a road. The mechanism includes a coupling mechanism capable of detachably coupling a frame to a vehicle. The mechanism includes a three-dimensional sensor that is positionally rigid with respect to its location on the frame, and that measures the surface upon which the vehicle is traveling so as to obtain a three-dimensional topography of that surface. A navigation system is provided to measure the position of the mechanism, and an inertial measurement unit is provided to measure an orientation of the mechanism, each at a given time.

Together, the sensor can measure the topography of the road by measuring the topography at regular intervals. The navigation system and inertial measurement unit can collectively output x, y, z, and t values of the mechanism for each interval. The topographical images at each interval can then be stitched together to form a full three-dimensional topography of the road. The detachable coupling mechanism can permit this operation to be performed on a wide variety of vehicles with relative ease by allowing the frame to be removed and attached to vehicles of different sizes.

In particular, the presently disclosed embodiments include a survey mechanism including a frame and a coupling mechanism configured to detachably couple the frame to a vehicle. The mechanism can further include at least one three-dimensional sensor coupled to the frame such that the at least one three-dimensional sensor defines a predetermined position relative to the frame. The at least one three-dimensional sensor faces a surface upon which the vehicle is traveling in a substantially vertical direction and is configured to measure a three-dimensional topography of the surface. The mechanism can also include a navigation system coupled to the frame and configured to measure and output a position of the mechanism at a given time, and an inertial measurement unit coupled to the frame and configured to measure and output an orientation of the mechanism at the given time.

In some embodiments, the survey mechanism further includes at least one camera coupled to the frame.

In some embodiments, the at least one camera faces a horizontal direction that is substantially parallel to the surface.

In some embodiments, the at least one camera is communicably coupled to the navigation system and the inertial measurement unit.

In some embodiments, the at least one camera includes a cover that defines a channel that permits air flow out of the cover and over the at least one camera.

In some embodiments, the cover includes a circumferential recess in which the at least one camera is positioned, and the channel is defined within the circumferential recess.

In some embodiments, the survey mechanism further includes a rear pod and a front pod, wherein at least one of the rear pod and front pod includes a vent that permits air flow into the rear pod and/or the front pod, respectively.

In some embodiments, the frame includes a beam that is hollow and that communicates with the vent so as to create a pressurized system when the vehicle is in motion.

In some embodiments, at least one of the rear pod and front pod include a cover that covers a camera, where the cover includes channels where air exits the pressurized system.

In some embodiments, the is beam is comprised of an extrudable material characterized by properties that facilitate a transformation of the extrudable material into a beam shape via an extrusion technique.

In some embodiments, the survey mechanism further includes a pin abutting the beam.

In some embodiments, the at least one three-dimensional sensor includes a laser and a laser sensor associated with the laser, the laser sensor being capable of receiving an angled reflection of the laser so as to determine a surface profile of the surface upon which the vehicle is moving via laser triangulation.

In some embodiments, the survey mechanism further includes a Light Detection and Ranging (LiDAR) sensor coupled to the frame and configured to detect a distance from the LiDAR sensor to an object.

In some embodiments, the survey mechanism further includes a front pod and a rear pod, wherein the front pod is arranged around a front pod common reference point defined as a virtual point within a LiDAR sensor of the front pod, and the rear pod is arranged around a rear pod common reference line that is defined as a virtual line extending through a vertical axis of a rear antenna of the rear pod.

In some embodiments, the survey mechanism further includes a front pod and a rear pod, wherein the navigation system includes a front navigation antenna positioned on the front pod, and a rear navigation antenna positioned on the rear pod.

In some embodiments, the survey mechanism further includes a data logger communicably coupled to, and configured to store data output by, the at least one three-dimensional sensor, the navigation system, and the inertial measurement unit.

In some embodiments, the survey mechanism further includes a shaft encoder associated with at least one wheel of the vehicle and configured to output data indicating a movement amount of the at least one wheel.

In some embodiments, the frame includes a beam having first and second ends, and the pin abuts the frame at one of the first and second ends.

In some embodiments, the frame includes a beam that is hollow.

In some embodiments, a survey mechanism is coupled to a vehicle and includes at

least one three-dimensional sensor facing a surface upon which the vehicle is traveling and configured to measure a three-dimensional topography of the surface, a navigation system configured to measure and output a position of the survey mechanism at a given time, an inertial measurement unit coupled configured to measure and output an orientation of the survey mechanism at the given time, and a coupling mechanism configured to detachably couple the three-dimensional sensor, navigation system, and inertial measurement unit to a vehicle.

### BRIEF DESCRIPTION OF THE SEVERAL VIEWS OF THE DRAWINGS

The present technology will be described with reference to the appended drawings. The drawings aid in the description of the present technology and are not to be considered to be limiting the scope of the appended claims. The accompanying drawings include:

FIG. 1 illustrates a front perspective view of a survey mechanism according to at least some of the presently disclosed embodiments.

FIG. 2 illustrates a top perspective view of a front pod with a front cover removed according to at least some of the presently disclosed embodiments.

FIG. 3 illustrates a rear perspective view of a rear pod according to at least some of the presently disclosed embodiments.

FIG. 4 illustrates a side schematic view of a survey system according to at least some of the presently disclosed embodiments.

FIGS. 5A and 5B illustrate side and top views of a schematic representation of the survey system according to at least some of the presently disclosed embodiments.

FIG. 6 illustrates an enlarged, rear perspective view of a camera with a channel formed in a recess within which the camera is located, according to at least some of the presently disclosed embodiments.

FIG. 7 illustrates an enlarged broken view of a beam abutting a pin according to at least some of the presently disclosed embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed embodiments relate to a portable, detachable survey mechanism that is easily calibrated whether attached or detached from a vehicle. By allowing a detachable coupling, the survey mechanism is not dependent on a vehicle chassis or required to be integrated into a dedicated vehicle. Rather, the survey mechanism can be removed from one vehicle and attached to another vehicle, improving its portability.

Dedicated vehicles are often required to be transported from one project to another to provide the required survey functionality. At least some of the presently disclosed embodiments allow the survey mechanism itself to be transported from project to project independent of a specific vehicle. This reduces the costs and effort associated with ensuring a project includes all required equipment necessary to measure a three-dimensional surface such as a road upon which a vehicle is traveling. The disclosed embodiments therefore enable the handling of smaller projects such as municipal projects where a surveying organization does not have a regional office or headquarters.

The disclosed mechanism includes a three-dimensional sensor that is positionally rigid with respect to its location on the frame such that the location of the sensor is known within the system. One or more three-dimensional sensors can be coupled to the frame and obtain a three-dimensional topography of the road and the surrounding environment upon which the vehicle travels. A navigation system is provided to measure the position of the mechanism, and an inertial measurement unit is provided to measure an orientation of the mechanism, each at a given time. The mechanism is therefore able to accurately measure a three-dimensional topography of a road and the surrounding environment and then the mechanism can be removed and transported to another site for the same purpose.

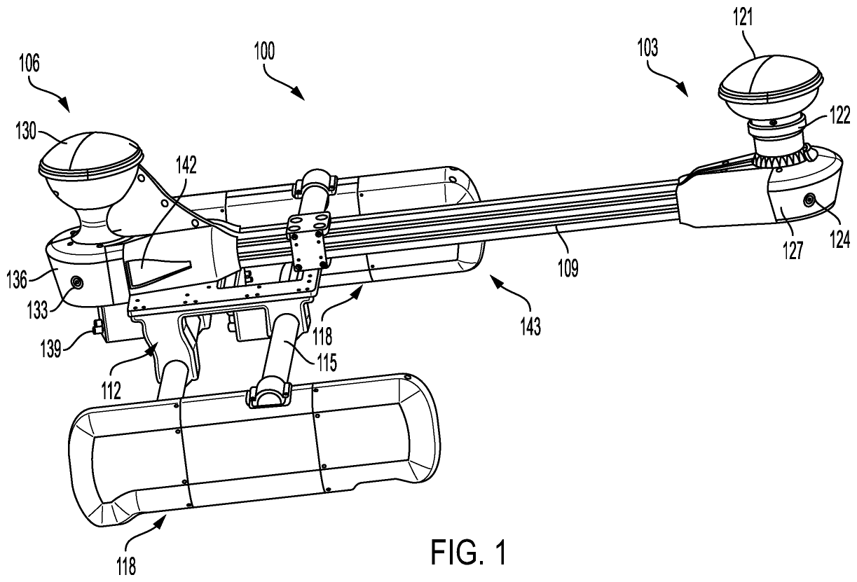

As shown in FIG. 1, a survey mechanism 100 includes a front pod 103 and a rear pod 106 with a beam 109 extending between the front pod 103 and the rear pod 106. The mechanism 100 can further include a frame 112 with at least one crossbar 115, and with at least one three-dimensional sensor 118 coupled to the crossbar 115. As discussed below in more detail, the three-dimensional sensor(s) 118 measure a three-dimensional topography of a surface upon which the vehicle is traveling, for example, a road.

The front pod 103 can include a front antenna 121 and a Light Detection and Ranging (LiDAR) sensor 122. The front pod 103 can also include one or more front pod camera(s) 124 and a front cover 127 surrounding the front pod camera(s) 124. Similarly, the rear pod 106 can include a rear antenna 130 and rear pod camera(s) 133, with a rear cover 136 surrounding the rear pod camera(s) 133. The at least one camera 124, 133 can be coupled to the frame 112. An inertial measurement unit 139 can be coupled to the rear pod 106 for measuring an orientation of the mechanism at a given time. In some embodiments, the rear pod 106 is rigidly coupled to the beam 109, which itself is rigidly coupled to the front pod 103, which is rigidly coupled to the frame 112, to comprise the entire rigid system of the mechanism 100. A vent 142 can be defined within the rear cover and can communicate with the rear pod camera(s) 133 to permit air flow over the rear pod camera(s) 133, as discussed below in more detail.

The front pod 103 can provide data more easily captured from the front portion of a vehicle through the various components of the front pod 103. The front pod 103 can include a front pod common reference point. For example, and without limitation, the front pod 103 common reference point can be a virtual point at a base of the LiDAR sensor 122, and the rear common reference point can be a vertical axis that extends through the vertical axis of the rear antenna 130. This front common reference point can be the virtual point at which the LiDAR sensor 122 treats as its origin for purposes of computing x, y, and z values of measured objects. The LiDAR sensor 122 and front antenna 121 can be aligned along a vertical axis that extends through this point to simplify the data processing steps when digitally recreating the surface and surrounding topography. Similarly, the rear common reference point can be a point on a vertical line that extends through the vertical axis of the rear antenna 130. In some embodiments, the rear common reference point is a point on the cover of the inertial measurement unit 139. The laser 148, inertial measurement unit 139, and rear antenna 130 can all be aligned along a plane that extends through this line. By establishing these two known points, the mechanism 100 can understand the exact position of the front pod 103 and rear pod 106 during the measurement process and measure other values with respect to these common reference points. By maintaining two common reference points, this also allows the beam 109 to be different lengths depending on the specific project.

The front antenna 121 and/or rear antenna 130 can be an antenna associated with a navigation system that measures and outputs a global position of the mechanism. To this end, the front antenna 121 and/or the rear antenna 130 can individually or collectively act as a navigation system coupled to the frame 112 and can be configured to measure and output a position of the mechanism 100 at a given time. For example, the navigation system can be a global positioning system (GPS), a global navigation satellite system (GNSS), an inertial navigation system (INS), a radio frequency identification (RFID) navigation system, a dead reckoning navigation system, a visual odometry system, a celestial navigation system, a beacon-based navigation system, a laser-based navigation system, or a magnetic navigation system.

The LiDAR sensor 122 can be coupled to the frame 112 and configured to detect a distance from the LiDAR sensor 122 to an object. The LiDAR can use eye-safe laser beams to “see” the world in three dimensions. For example, the LiDAR sensor 122 emits laser pulses towards objects in its vicinity and measures the time it takes for the pulses to reflect back to the sensor after reaching the objects. By precisely timing the return of these pulses, the LiDAR sensor 122 calculates the distance to each object, creating a detailed three-dimensional map of the environment. The LiDAR sensor 122 is also able to output distance measurement data so that the system can correlate that data with images captured by the front pod camera 124 or rear pod camera 133. In this manner, the distance to the images can be determined. Additionally, the LiDAR sensor 122 captures the intensity of the returned laser light, providing information about the objects' reflectivity or material properties.

The front pod camera(s) 124 and the rear pod camera(s) 133 can be coupled to the frame 112 and can face a substantially horizontal direction that is substantially parallel to the surface upon which the vehicle is traveling. The front pod camera(s) 124 and rear pod camera(s) 133 can be any camera capable of capturing all or part of an image. For example, the front pod camera 124 can be a digital single-lens reflex (DSLR) camera, a mirrorless camera, a compact digital camera, a panoramic camera, a thermal imaging camera, a multispectral camera, or a hyperspectral camera. The choice of camera depends on factors such as the desired image resolution, spectral sensitivity, field of view, and environmental conditions in which the surveying mechanism operates. By employing a suitable camera, the front pod camera(s) 124 facilitates the acquisition of high-quality visual data essential for precise surveying and mapping applications. The rear pod camera(s) 133 can be the same type of camera as the front pod camera 124 or, in some embodiments, is a different camera. Further, as will be described in more detail below, the front pod camera 124 and rear pod camera 133 can be a plurality of cameras angularly separated to capture a wide range of images, in some cases 360 degrees of images.

The frame 112 can act as the structural backbone of the mechanism 100. For example, the beam 109 can be considered part of the frame 112 in some embodiments, because the front pod 103 couples to the rear pod 106 via the beam 109. The crossbars 115, beam 109, and the frame 112 can be rigid so that locational accuracy can be confirmed within the data collected by the mechanism 100. In general, the frame 112 is meant to be interpreted broadly as including any structural component upon which the functional components of the mechanism 100 are coupled.

In an embodiment, the frame 112 is formed by an extrusion technique. For example, the frame 112 can be made of an extrudable material characterized by properties that facilitate a transformation of the extrudable material into a beam shape via an extrusion technique. The material may include, but is not limited to, metals such as aluminum or steel, plastics, or composite materials, each selected for their balance of strength, durability, and weight.

The extrusion process can involve forcing the chosen material through a die to achieve the desired cross-sectional profile, which is specifically designed to optimize the structural integrity and functionality of the frame 112. This process allows for the creation of complex cross-sectional shapes that are uniform in density and consistency, enhancing the load-bearing capacity and resistance to environmental stresses for the frame 112. Additionally, the extrusion technique enables the integration of features such as channels for wiring or aerodynamic contours directly into the frame 112 structure, reducing the need for additional components and simplifying assembly. The use of extrusion in forming the frame 112 not only ensures a high degree of precision and uniformity in the production process but also offers the flexibility to tailor the properties of the frame 112, such as rigidity, flexibility, and thermal conductivity, to specific application requirements.

The mechanism 100 can include a coupling mechanism 143 configured to detachably couple the frame 112 to a vehicle. In doing so, the mechanism 100 does not require a dedicated vehicle but instead can be removed from one vehicle and attached to another. The coupling mechanism 143 can be, for example, a clamp system, magnetic attachment, suction device, mechanical fasteners such as bolts or screws, snap-fit connectors, locking pins, hook-and-loop fasteners, adhesive bonding, quick-release mechanisms, or any combination thereof. Additionally, the coupling mechanism 143 may incorporate adjustable or telescoping features to accommodate different vehicle dimensions, as well as built-in safety locks or release triggers to enhance security and ease of detachment when required. The coupling mechanism 143 also may include shock and vibration damping components. These shock and vibration components decouple the dynamics of the vehicle from the survey mechanism 100 to achieve better data collection precision.

The inertial measurement unit 139 can be coupled to the frame and configured to measure and output an orientation of the mechanism 100 at a given time. In an embodiment, the inertial measurement unit 139 can measure and report acceleration, angular rate, and magnetic field data, enabling tasks such as motion tracking, navigation, and stabilization. In an embodiment with multiple three-dimensional sensors 118, the inertial measurement unit 139 can output data permitting the angle between the plurality of three-dimensional sensors 118 to be determined. For example, the inertial measurement unit 139 can dynamically measure an angle between the plurality of three-dimensional sensors 118 during operation of the mechanism 100.

The inertial measurement unit 139 can be any device capable of measuring the inertia of the vehicle and/or the mechanism 100 and an angle thereof. For example, the inertial measurement unit 139 can be an Inertial Measurement Unit (IMU) incorporating accelerometers, gyroscopes, and magnetometers to precisely determine the vehicle's linear and angular motion in three-dimensional space. Alternatively, the inertial measurement unit 139 can include MEMS (Micro-Electro-Mechanical Systems) sensors, fiber optic gyroscopes, or piezoelectric sensors, each offering unique advantages in terms of size, accuracy, and power consumption for effectively monitoring and analyzing the vehicle's dynamics and orientation.

The navigational system and inertial measurement unit 139 can be designed to determine precise spatial and orientation data in a global reference frame. Specifically, these features can collectively deliver coordinates in three dimensions (X, Y, Z), orientation data (heading, roll, pitch), and time synchronization, all referenced to the navigation system framework. The orientation components—heading, roll, and pitch—are ascertained based on local-level measurements, correlating with gravitational forces at the specific location of measurement. The system utilizes a defined geometric relationship, encompassing both the coordinates (X, Y, Z) in the frame 112 and rotational angles around these three axes. Understanding this geometric configuration, the system is capable of translating the sensor-specific data into the global context.

The three-dimensional sensor 118 is coupled to the frame 112 in a positionally rigid manner. That is, the three-dimensional sensor 118 is coupled to the frame such that the three-dimensional sensor 118 defines a predetermined position relative to the frame 112. The three-dimensional sensor 118 faces a surface upon which the vehicle is traveling in a substantially vertical direction and is configured to measure a three-dimensional topography of the surface.

In an embodiment, and as shown, multiple three-dimensional sensors 118 are provided for broader collection of surface data. For example, the three-dimensional sensors 118 can be positioned a fixed distance apart from one another on opposite sides of the mechanism and their field of scan can overlap slightly to ensure full coverage of the surface while also allowing the overlap region to act as a calibration region. As will be described below in more detail, the three-dimensional sensor(s) 118 can determine the three-dimensional topography of the surface through laser line triangulation.

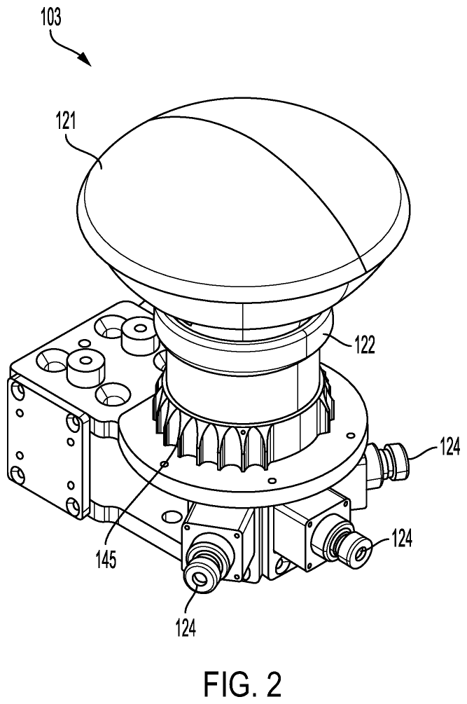

FIG. 2 illustrates a top perspective view of the front pod 103 with the front cover 127 removed according to at least some of the presently disclosed embodiments. As shown, the front pod 103 can include a plurality of front pod cameras 124. In the embodiment shown in FIG. 2, the front pod 103 includes three front pod cameras 124 angularly spaced to provide a wider range of images that can be captured by the front pod cameras 124. Any number of front pod cameras 124 can be implemented without departing from the spirit and scope of the presently disclosed embodiments.

The front pod 103 can also include heat fins 145 associated with the front pod 103 and capable of directing heat away from the front pod 103. However, any other structure or method of heat dissipation can be implemented without departing from the spirit and scope of the presently disclosed embodiments. For example, the front pod 103 can include a liquid cooling system with heat pipes, thermoelectric coolers, phase-change materials, or vapor chambers for efficient heat dissipation. Alternatively, the front pod 103 can integrate heat sinks made of materials with high thermal conductivity, such as copper or aluminum alloys, or employ active cooling solutions like fans or Peltier coolers to manage heat generated within the front pod 103.

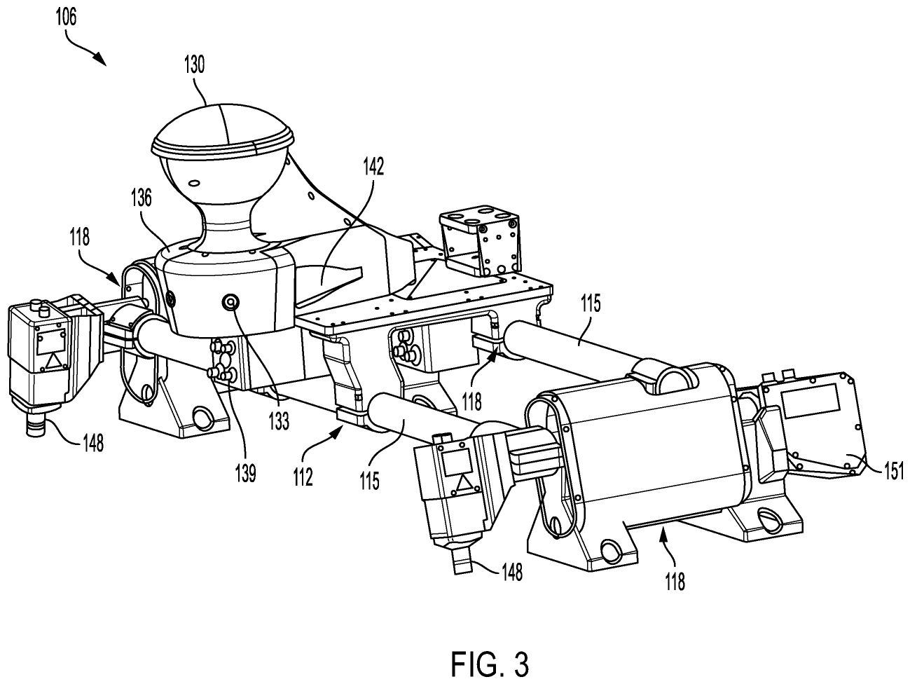

FIG. 3 illustrates a rear perspective view of the rear pod 106 according to at least some of the presently disclosed embodiments. The covering of the three-dimensional sensors 118 is shown as removed in FIG. 3 to provide a better depiction of the internal components of the three-dimensional sensors 118. As shown, the three-dimensional sensor 118 can include a laser 148 and a laser sensor 151 associated with the laser 148 and capable of receiving an angled reflection of the laser 148 so as to measure the surface upon which the vehicle is moving via laser triangulation. Specifically, laser line triangulation can be used to capture a single transverse profile of the surface (e.g., the road pavement). When combined, these sequential transverse profiles form a three-dimensional pavement surface profile.

Laser triangulation is a technique used for measuring distances or shapes using a laser beam. In some embodiments, the laser sensor 151 is a camera, and the surface is measured by projecting a laser onto a surface and taking an image of that surface at an angle with the laser sensor 151. By analyzing the image, the distance between the laser source and the surface can be calculated, enabling precise measurements and three-dimensional scanning applications. This two-dimensional image can be taken at regular intervals, and the multiple two-dimensional images can then be “stitched” together during computer processing to form a three-dimensional image. Accordingly, in some embodiments, the three-dimensional sensor(s) 118 are in some respects not three-dimensional at all, but are in fact two-dimensional pictures of a projected laser line that are repeated at regular intervals to provide the three-dimensional topography.

The laser 148 and laser sensor 151 can be any type of laser 148 and laser sensor 151 capable of carrying out laser triangulation. For example, the laser 148 can be a semiconductor laser diode emitting a narrow and coherent beam with sufficient power and wavelength stability for accurate distance measurements. The laser sensor 151 can be a photodetector or a charge-coupled device (CCD) capable of rapidly capturing the reflected laser light and converting it into precise distance measurements, providing high-resolution surface topography data, but in an embodiment, is a camera.

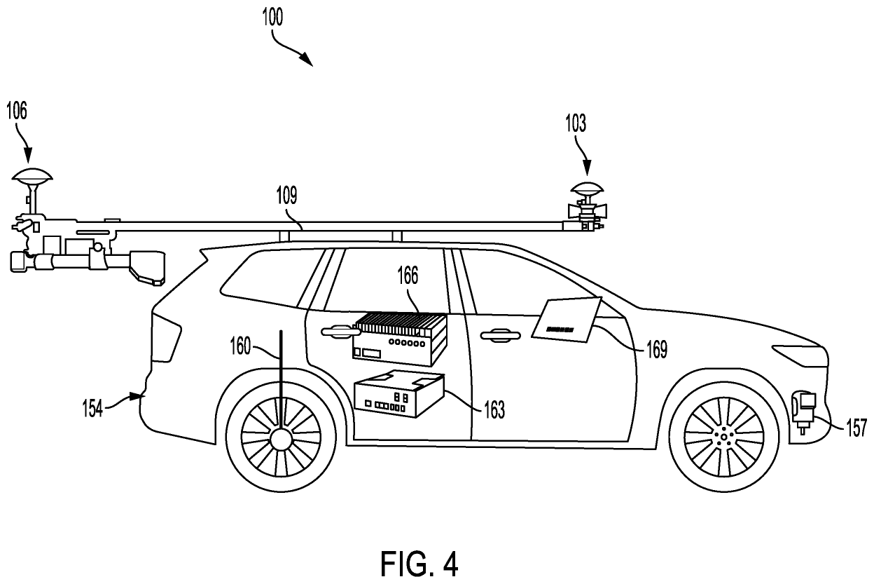

FIG. 4 illustrates a side schematic view of a survey system according to at least some of the presently disclosed embodiments. As shown, the mechanism 100 is detachably coupled to a vehicle 154. The internal electrical components associated with the mechanism 100 are shown in schematic form.

As shown, the mechanism 100 can be associated with an auto-start sensor 157 for beginning the process of collecting topographical data with the functional components of the mechanism 100. A shaft encoder 160 is provided for measuring a movement of at least one wheel of the vehicle 154, and a data logger 163 can receive data from the functional components. A control computer 166 can be provided for controlling either the vehicle 154 and/or the functional components of the mechanism 100, and a user interface 169 can be provided for allowing a user to interface with the components.

The vehicle 154 can be any movable object that can be controlled by a person or computer. In some embodiments, the vehicle 154 is a car, truck, trailer, scooter, go kart, airplane, helicopter, or any other transportable object. In some embodiments, the vehicle is autonomous and operates with little or no real-time interaction by a human.

The auto-start sensor 157 can provide a signal to the control computer 166 to initiate the collection of data upon the sensing of vehicle movement. For example, the auto-start sensor 157 can be a motion sensor, such as an accelerometer or a Doppler radar sensor, installed within the housing of the vehicle 154 or attached to a chassis of the vehicle 154. Additionally, the auto-start sensor 157 may utilize global positioning data (e.g., GPS data or data from the navigation system) or wheel speed sensors to detect the onset of vehicle motion, ensuring precise synchronization between data collection and vehicle movement.

The shaft encoder 160 can be associated with at least one wheel of the vehicle 154 and can output data indicating a movement amount of the at least one wheel. The shaft encoder 160 can be any device for measuring the movement of at least one wheel of the vehicle 154. For example, the shaft encoder 160 can be an optical encoder that utilizes a rotating disk with slots or markings to generate electrical pulses as the wheel turns, providing precise measurements of distance traveled or rotational position. Alternatively, the shaft encoder 160 may employ a magnetic encoder, which utilizes the changes in magnetic field patterns as the wheel rotates to determine motion. Additionally, the shaft encoder 160 could be a mechanical encoder utilizing gears or other mechanical mechanisms to track wheel movement accurately.

The data logger 163 can be communicably coupled to, and store data output by, the plurality of three-dimensional sensors 118, navigation system, front and rear pod cameras 124, 133, and inertial measurement unit 139. The data logger 163 can be any non-transitory computer-readable recording medium capable of recording, storing, and/or organizing data collected by the mechanism 100. For example, the data logger 163 can be a solid-state data storage device such as flash memory, a hard disk drive, or a solid-state drive. Alternatively, the data logger 163 may incorporate wireless communication capabilities to transmit real-time data to a remote server or a computing device for further analysis and processing. The data logger 163 can also feature encryption mechanisms to ensure the security and integrity of the stored surveying data. The data logger 163 can therefore act as a storage associated with the plurality of three-dimensional sensors 118 and inertial measurement unit 139 and can receive data from the plurality of three-dimensional sensors 118 and inertial measurement unit 139.

The control computer 166 can be any computing device capable of directly or indirectly controlling the vehicle 154. For example, the control computer 166 can be a traditional personal computer with desktop or laptop configurations, or a modern handheld device such as a smartphone or tablet. The control computer 166 can include storage for storing data output from the mechanism 100, user selections, an operating system for the control computer 166, applications and services necessary or helpful for the collection of data, or software for controlling the operation of the vehicle 154. The control computer 166 can also include a transceiver for transmitting and receiving data, as well as a processor for executing instructions, performing calculations, managing data flow, and serving as the central component responsible for carrying out computational tasks in the control computer 166. The control computer 166 can also provide the means for communicably coupling the navigation system and inertial measurement unit 139 by analyzing and synchronizing the data output therefrom. In this manner, the control computer 166 can communicably couple the at least one camera 124, 133 to the navigation system and the inertial measurement unit 139.

The user interface 169 can be any component capable of allowing user interaction with the data collected by the mechanism 100 and/or the controls of the mechanism 100. For example, the user interface 169 can be a touchscreen display integrated into the mechanism 100, providing intuitive access to collected surveying data, control settings, and system diagnostics. Alternatively, the user interface 169 may include physical buttons, knobs, or switches along with a liquid crystal display (LCD) screen or light-emitting diode (LED) indicators for displaying relevant information and facilitating user input. Furthermore, the user interface 169 can incorporate audio feedback or voice commands to enhance usability. In some embodiments, the user interface 169 is incorporated into the vehicle 154 as a non-detachable fixture. In other embodiments, the user interface 169 is detachable, and is a tablet, personal computer, smart phone, or any other device capable of collecting user input. The user interface 169 can include navigation instructions, status reporting, error messages or other information necessary or helpful to the operation of the mechanism 100.

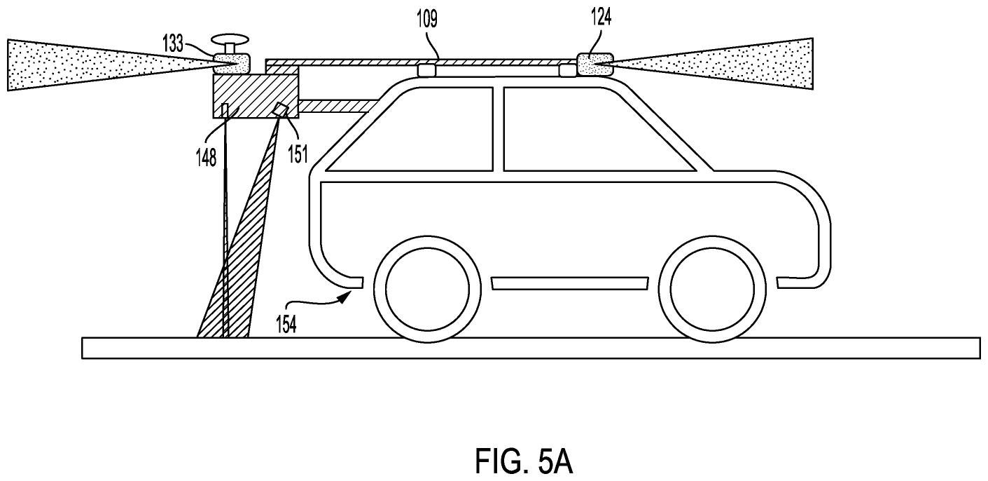

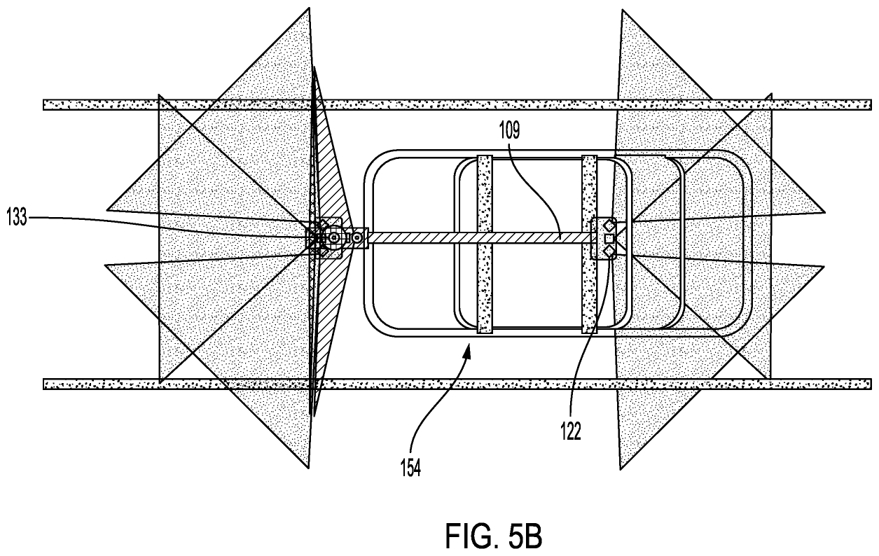

FIGS. 5A and 5B illustrate side, top, and front views of a schematic representation of the survey system according to at least some of the presently disclosed embodiments. As shown, the laser 148 and laser sensor 151 can scan a surface upon which the vehicle 154 travels, for example a road. The front pod camera 124 and rear pod camera 133 can capture images at select intervals.

In an embodiment, the front pod camera 124 and/or the rear pod camera 133 can capture images at predefined intervals. For example, in an embodiment, the cameras 124, 133 can capture images at predetermined time intervals. In another embodiment, the cameras 124, 133 can capture images every 6 m based on a distance driven as determined by the navigation system and/or the shaft encoder 160 measuring movement of the wheel. Any other manner of measuring vehicle movement or time can be implemented, for example, by outputting data from the vehicle odometer, visual odometry, or any other method.

The laser sensor 151 can similarly capture an image of the laser line emitted by the laser 148 at any interval. In an embodiment, the laser sensor 151 captures an image at a rate of approximately 28 KHz. The laser 148 and laser sensor 151 can be coupled to the frame 112 at any position, but in an embodiment, are coupled to the frame 112 at a distance of 1.5 meters above the surface upon which the vehicle 154 travels to allow safe clearance.

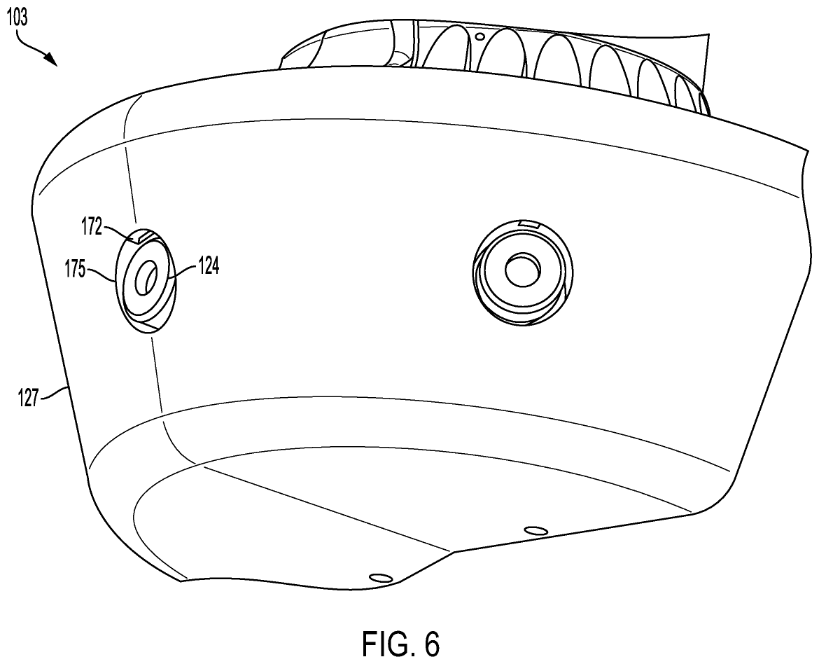

FIG. 6 illustrates an enlarged, rear perspective view of a front pod camera 124 with a channel 172 formed in a recess 175 within which the front pod camera 124 is located, according to at least some of the presently disclosed embodiments. Although FIG. 6 illustrates this feature with the front pod camera 124, it is contemplated that the same functionality can be implemented for the rear pod camera 133, without departing from the spirit and scope of the presently disclosed embodiments.

As shown, the front pod camera 124 can be positioned within a recess 175 of the front cover 127. This allows the front pod camera 124 to avoid protruding outward and colliding with objects, but also allows the front pod camera 124 to collect images without being obstructed by the housing within which it is situated. The recess 175 can be circumferential, as shown, and can surround the front pod camera 124 such that the front pod camera 124 is positioned within the circumferential recess 175. The recess 175 can define a channel 172 that permits air flow out of the front cover 127 and over the front pod camera 124. For example, the channel 172 can extend partially radially, around a partial circumference of the recess 175, and partially axially within the front cover 127, around an axis of the front pod camera 124. In doing so, the front pod camera 124 is ventilated and can be free from moisture and debris that may hinder its ability to capture images.

Returning to FIG. 1, the vent 142 allows air to enter the rear pod 106 via the rear cover 136. That is, the rear pod 106 includes the rear cover 136 with the vent 142 defined therein, and the vent 142 communicates with the rear pod camera 133 to permit air flow over the rear pod camera 133. In some embodiments, either the rear pod 106 and/or the front pod 103 can include the vent 142 that permits air to flow into the rear pod 106 and/or the front pod 103, respectively.

The flow of air into the vent 142 creates pressurized air pockets in the rear cover 136 and the front cover 127, respectively. For example, the rear pod 106 can have a rear cover 136 that permits air flow into the rear cover 136 via the vent 142. The frame 112 includes a beam 109 that is hollow so as to permit air passage from the vent 142 to the front cover 127 and create a pressurized system when the vehicle is in motion.

In particular, a vehicle can travel and, in doing so, allow air to pass into the rear cover 136 through the vent 142 and out through a channel 172 in the front pod 103 or rear pod 106. This can create pockets such that the beam 109 is pressurized passively by air flowing into the mechanism during travel. The pockets thereby create an air dam so as to prevent introduction of bugs or other debris onto the lenses or other components of the cameras arranged within the front cover 127 and rear cover 136. In this manner, the rear pod 106 and/or front pod 103 can include a cover 136, 127 that covers the cameras 133, 124, where the covers 136, 127 include the channels 172 where the air exits the pressurized system.

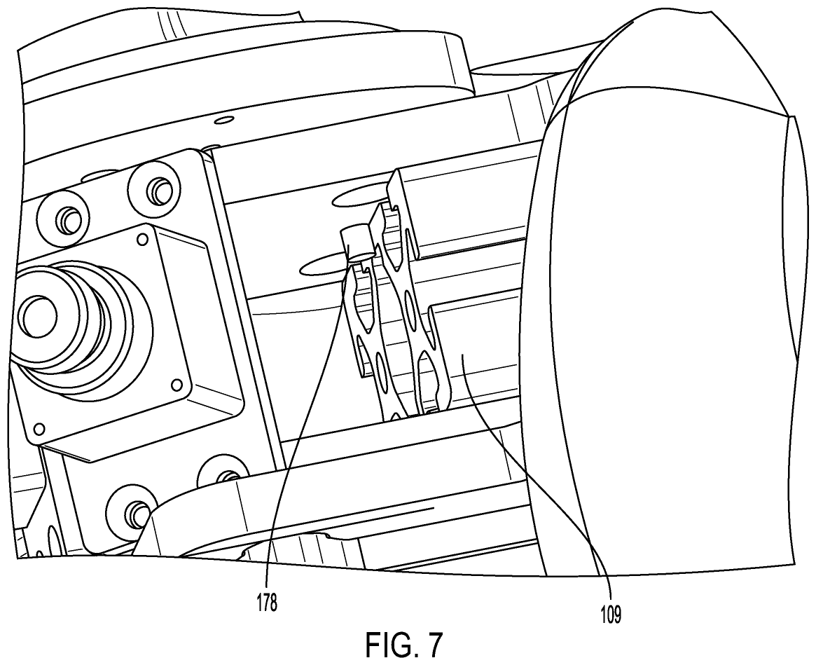

FIG. 7 illustrates an enlarged broken view of a beam abutting a pin according to at least some of the presently disclosed embodiments. As shown, the mechanism 100 includes a beam 109 having first and second ends, and the pin 178 abuts the beam 109 at either the front pod 103 or the rear pod 106, or in any other known location. In doing so, the system can confirm the beam 109 is measured from the point of the pin 178 due to the fact that the beam 109 abuts the pin 178 for positional confirmation. The beam 109 can also be different sizes due to this structure, because the pin 178 can act as the origin point from which the beam 109 is measured to configure the mechanism 100 if a different size beam is used.

As described herein, the mechanism 100 can collect and store a wide variety of data with the various three-dimensional sensors 118, LiDAR sensor 122, cameras 124, 133, and inertial measurement unit 139. For example, and without limitation, the mechanism can collect data relating to road and pavement data for maintenance, planning, or pavement management. This data can include, for example, raw road profile data, a longitudinal profile of the road, roughness or smoothness data, macro texture of the pavement surface, or any other physical road data. In particular, when the vehicle 154 is driven, the mechanism 100 can capture sequential transverse profiles of the pavement surface and when combined, these sequential transverse profiles form a three-dimensional pavement surface profile. The mechanism can also collect “above ground” data such as the location and shape of a street sign, guard rail, light pole, or other objects, with the various cameras 124, 133, and LiDAR sensor 122, and in some cases in association with the other components of the mechanism 100.

Benefits, other advantages, and solutions to problems have been described herein with regard to specific embodiments. However, the benefits, advantages, solutions to problems, and elements that may cause any benefit, advantage, or solution to occur or become more pronounced are not to be construed as critical, required, or essential features or elements of the disclosure.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

Further, it should be appreciated that in the appended claims, reference to an element in the singular is not intended to mean “one and only one” unless explicitly so stated, but rather “one or more.”

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

The words “illustrative” or “exemplary” are used herein to mean “serving as an example, instance, or illustration.” Any aspect described herein as “illustrative” or “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

1. A survey mechanism comprising:
a frame;
a coupling mechanism configured to detachably couple the frame to a vehicle;
at least one three-dimensional sensor coupled to the frame such that the at least one three-dimensional sensor defines a predetermined position relative to the frame, wherein the at least one three-dimensional sensor faces a surface upon which the vehicle is traveling and is configured to measure a three-dimensional topography of the surface;
a navigation system coupled to the frame and configured to measure and output a position of the survey mechanism at a given time; and
an inertial measurement unit coupled to the frame and configured to measure and output an orientation of the survey mechanism at the given time.

2. The survey mechanism of claim 1, further comprising at least one camera coupled to the frame.

3. The survey mechanism of claim 2, wherein the at least one camera faces a horizontal direction that is substantially parallel to the surface.

4. The survey mechanism of claim 2, wherein the at least one camera is communicably coupled to the navigation system and the inertial measurement unit.

5. The survey mechanism of claim 2, further comprising a cover that defines a channel that permits air flow out of the cover and over the at least one camera.

6. The survey mechanism of claim 5, wherein the cover includes a circumferential recess in which the at least one camera is positioned, and wherein the channel is defined within the circumferential recess.

7. The survey mechanism of claim 1, further comprising:
a rear pod and a front pod, wherein at least one of the rear pod and front pod includes a vent that permits air flow into the rear pod and/or the front pod, respectively.

8. The survey mechanism of claim 7, wherein the frame includes a beam that is hollow and that communicates with the vent so as to create a pressurized system when the vehicle is in motion.

9. The survey mechanism of claim 8, wherein at least one of the rear pod and front pod include a cover that covers a camera, the cover including channels where air exits the pressurized system.

10. The survey mechanism of claim 1, wherein the is beam is comprised of an extrudable material characterized by properties that facilitate a transformation of the extrudable material into a beam shape via an extrusion technique.

11. The survey mechanism of claim 1, further comprising a pin abutting the beam.

12. The survey mechanism of claim 1, wherein the at least one three-dimensional sensor includes a laser and a laser sensor associated with the laser, the laser sensor being capable of receiving an angled reflection of the laser so as to determine a surface profile of the surface upon which the vehicle is moving via laser triangulation.

13. The survey mechanism of claim 1, further comprising a Light Detection and Ranging (LiDAR) sensor coupled to the frame and configured to detect a distance from the LiDAR sensor to an object.

14. The survey mechanism of claim 1, further comprising a front pod and a rear pod, wherein the front pod is arranged around a front pod common reference point defined as a virtual point within a LiDAR sensor of the front pod, and the rear pod is arranged around a rear pod common reference line that is defined as a virtual line extending through a vertical axis of a rear antenna of the rear pod.

15. The survey mechanism of claim 1, further comprising a front pod and a rear pod, wherein the navigation system includes a front navigation antenna positioned on the front pod, and a rear navigation antenna positioned on the rear pod.

16. The survey mechanism of claim 1, further comprising a data logger communicably coupled to, and configured to store data output by, the at least one three-dimensional sensor, the navigation system, and the inertial measurement unit.

17. The survey mechanism of claim 1, further comprising a shaft encoder associated with at least one wheel of the vehicle and configured to output data indicating a movement amount of the at least one wheel.

18. The survey mechanism of claim 9, wherein the frame includes a beam having first and second ends, and the pin abuts the frame at one of the first and second ends.

19. The survey mechanism of claim 1, wherein the frame includes a beam that is hollow.

20. A survey mechanism coupled to a vehicle and comprising:
at least one three-dimensional sensor facing a surface upon which the vehicle is traveling and configured to measure a three-dimensional topography of the surface;
a navigation system configured to measure and output a position of the survey mechanism at a given time;
an inertial measurement unit coupled configured to measure and output an orientation of the survey mechanism at the given time; and
a coupling mechanism configured to detachably couple the three-dimensional sensor, navigation system, and inertial measurement unit to a vehicle.
